(19) United States
(12) Patent Application Publication
(10) Pub. No.: US 2025/0197259 A1
(43) Pub. Date: Jun. 19, 2025

(54) CATALYST FOR DECOMPOSING NON-DEGRADABLE POLLUTANTS AND NON-DEGRADABLE POLLUTANT DECOMPOSITION SYSTEM INCLUDING THE CATALYST

(71) Applicant: University-Industry Cooperation Group of Kyung Hee University, Yongin-si (KR)

(72) Inventor: Jongsik KIM, Seongnam-si (KR)

(21) Appl. No.: 18/815,160

(22) Filed: Aug. 26, 2024

(30) Foreign Application Priority Data
Dec. 18, 2023 (KR) 10-2023-0184773

(51) Int. Cl. C02F 1/72; B01J 27/18; B01J 27/25; B01J 35/40; B01J 35/61; B01J 37/18; C02F 1/461; C02F 1/467; C02F 101/34; C02F 101/38

(52) U.S. Cl. CPC C02F 1/725; B01J 27/18; B01J 27/25; B01J 35/40; B01J 35/613; B01J 35/615; B01J 37/18; C02F 1/46109; C02F 1/4672; C02F 1/722; C02F 2001/46142; C02F 2001/46161; C02F 2101/34; C02F 2101/38; C02F 2101/40; C02F 2305/026

(57) ABSTRACT

An embodiment relates to a catalyst for decomposing non-degradable pollutants and a non-degradable pollutant decomposition system including the same, and more specifically, to a catalyst for an electro-/nonelectro-Fenton reaction system, the catalyst including at least one of 1) non-reducible transition metal oxide particles having a reduced surface, or 2) non-reducible transition metal oxide particles functionalized with H_{3-Z}PO₄^{Z-} (Z=1 to 3) and having a reduced surface; an electrode including the catalyst for the electro-/nonelectro-Fenton reaction system; and an electro-/nonelectro-Fenton reaction system using the electrode, for efficient decomposition of non-degradable organic matter.

### CROSS-REFERENCE TO RELATED APPLICATION

This application claims priority to and the benefit of Korean Patent Application No. 10-2023-0184773, filed on Dec. 18, 2023, the disclosure of which is incorporated herein by reference in its entirety.

### BACKGROUND

### Field of the Invention

The present invention relates to a catalyst for decomposing non-degradable pollutants and a non-degradable pollutant decomposition system including the same, and more specifically, to a catalyst for an electro-/nonelectro-Fenton reaction system, the catalyst including at least one of 1) non-reducible transition metal oxide particles having a reduced surface, or 2) non-reducible transition metal oxide particles functionalized with H^{3-Z}PO₄^{Z-} (Z=1 to 3) and having a reduced surface; an electrode including the catalyst for the electro-/nonelectro-Fenton reaction system; and an electro-/nonelectro-Fenton reaction system using the electrode, for efficient decomposition of non-degradable organic matter.

### Discussion of Related Art

One of the mineralization technologies (converting into H₂O/CO/CO₂, etc.) of wastewater including non-degradable organic matter such as phenols, environmental hormones, and residual pharmaceuticals is advanced oxidation process (AOP) that oxidizes and decomposes non-degradable or toxic organic matter contained in the water by generating radical oxidants (e.g., ·OH) with a high standard oxidation potential in the wastewater. One of the representative AOPs is the nonelectro-Fenton reaction process, which converts a radical precursor into a radical by adding it to a catalyst, and uses the radical to oxidize and decompose non-degradable organic matter. Another representative AOP is the electro-Fenton reaction process, which oxidizes and decomposes non-degradable organic matter by applying voltage between an anode that is not coated with a catalyst and a cathode that is coated with a catalyst. The electro-Fenton reaction process offers two major advantages over the nonelectro-Fenton reaction process: 1) a large amount of hydrogen peroxide (H₂O₂) (2H⁺+O₂+2e⁻→H₂O₂) may be supplied by the oxygen reduction occurring at the cathode, and 2) a significant amount of ·OH may be supplied by the heterolysis of hydrogen peroxide (H₂O₂ heterolysis; H₂O₂→OH⁻+·OH+e⁻; e⁻: electron) on the transition metal oxide catalyst surface coated on the cathode based on heterogeneous catalysis or homolysis (H₂O₂ homolysis; H₂O₂→·OH+·OH)

Generally, when a reducible transition metal oxide (e.g., MnO₂, Fe₂O₃, Co₂O₃, NiO, or CuO) is coated on the cathode of the electro-Fenton reaction process, and Mn⁴⁺, Fe³⁺, Co³⁺, Ni²⁺, and Cu²⁺ (hereinafter referred to as Mⁿ⁺) inherent on their surface are used as reactive surface species, hydrogen peroxide causes H₂O₂ heterolysis to generate ·OH and M⁽ⁿ⁺¹⁾⁺ (H₂O₂+Mⁿ⁺→OH⁻+·OH+M⁽ⁿ⁺¹⁾⁺). The generated M⁽ⁿ⁺¹⁾⁺ is reduced to Mⁿ⁺ by the abundant electrons (e⁻) in the reaction solution (e⁻ reduction: M⁽ⁿ⁺¹⁾⁺+e⁻→Mⁿ⁺), so that it may be recycled for the H₂O₂ heterolysis. On the other hand, when the cathode of the electro-Fenton reaction process is coated with a non-reducible transition metal oxide (e.g., ZrO₂, Nb₂O₅, or Ta₂O₅) and the Zr⁴⁺, Nb⁵⁺, and Ta⁵⁺ (hereinafter referred to as Mⁿ⁺) inherent on their surface are used as reactive surface species, hydrogen peroxide causes H₂O₂ homolysis to generate ·OH, but the reaction does not involve oxidation of Mⁿ⁺ (generation of Mⁿ⁺¹⁾⁺) (H₂O₂+Mⁿ⁺→·OH+·OH+Mⁿ⁺).

Non-reducible transition metal oxide surface reactive species may provide two advantages over reducible transition metal oxide surface reactive species for hydrogen peroxide decomposition reaction as described below. For example, 1) non-reducible transition metal oxide surface reactive species may induce H₂O₂ homolysis (H₂O₂→2·OH), which may double the productivity/production of ·OH compared to H₂O₂ heterolysis (H₂O₂→OH⁻+·OH), and 2) since the oxidation state of Mⁿ⁺ (e.g., Zr⁴⁺, Nb⁵⁺, Ta⁵⁺) remains unchanged even after H₂O₂ homolysis, electron reduction (e⁻ reduction) to cause hydrogen peroxide decomposition reaction to occur continuously is unnecessary.

In the case of the electro-Fenton reaction process, which is configured for the purpose of producing ·OH based on the H₂O₂ homolysis of non-reducible transition metal oxides, despite the above-described advantages, the scaling-up and commercialization of the electro-Fenton reaction process for wastewater treatment are limited due to the disadvantages described below. First, the limited amount of transition metal surface species (Zr⁴⁺, Nb⁵⁺, Ta⁵⁺) present on the catalyst surface coated on the cathode generates a limited amount of ·OH, which slows down the decomposition rate of non-degradable organic matter by ·OH. Second, the electro-Fenton reaction process performed under relatively harsh conditions causes continuous and severe leaching of metal species present on the catalyst surface coated on the cathode, which limits the number of times of using the coated catalyst and causes a decrease in the organic matter decomposition performance. Third, the ·OH applied in the electro-Fenton reaction process has a relatively short lifetime, and thus lowers the efficiency of organic matter decomposition and requires a limited range of pH for the efficient production of ·OH.

Importantly, in the case of TiO₂, which belongs to the category of non-reducible transition metal oxides, the band gap energy may be reduced to less than 3.0 eV by hydrogen (H₂) reduction, so that TiO₂ may create holes in the valence band and locate electrons (e⁻) in the conduction band under visible light/ultraviolet light (TiO₂+hv (visible light/ultraviolet light)→h_{VB}⁺+e_{CB}⁻; VB: valence band; h: hole; CB: conduction band). In other words, in the case of the reduced TiO₂, 1) H₂O or OH⁻ may converted by a semiconducting mechanism into ·OH, O₂·⁻ and ¹O₂ under visible light/ultraviolet light, or 2) after forming a composite with a substance (including Mⁿ⁺) that causes H₂O₂ heterolysis (H₂O₂+Mⁿ⁺→OH⁻+·OH+M⁽ⁿ⁺¹⁾⁺), electrons (e⁻) located in the conduction band may easily reduce M⁽ⁿ⁺¹⁾⁺ formed after the H₂O₂ heterolysis by a heterojunction mechanism under visible light/ultraviolet light, thereby improving the ·OH productivity. Nevertheless, there are no examples where reduced TiO₂ is used as an activating catalyst for H₂O₂ homolysis (H₂O₂→2·OH) in the absence of visible light/ultraviolet light.

Table 1 below shows the standard oxidation potentials and half-lives of radicals.

TABLE 1

| | ^{•}OH | NO₃^{•} | H₂PO₄^{•} | HPO₄^{•-} | PO₄^{2•-} |
|---|---|---|---|---|---|
| Standard oxidation | 2.7 | 2.3 | 2.4 | 2.4 | 2.4 |
| potential (V) | | | | | |
| Half-life (X10⁻⁶ sec) | 10⁻³ | 60 | 100 | 100 | 100 |

In addition, as shown in Table 1, although ·OH provides a high standard oxidation potential compared to NO³·, H₂PO₄·, HPO₄·⁻, or PO₄²·⁻ it has disadvantages such as a very short half-life and a narrow pH range for easy generation of ·OH, so the decomposition efficiency of non-degradable organic matter may not be significant compared to NO³·, H₂PO₄·, HPO₄·⁻, or PO₄²·⁻. In addition, in the case of NO³·, H₂PO₄·, HPO₄·⁻, or PO₄²·⁻, despite their slightly lower standard oxidation potentials and the significantly long half-life compared to ·OH, since they are limitedly generated under very harsh conditions (for example, generated under very low pH or in the presence of radioactive elements), they may not be easily used for the decomposition of non-degradable organic matter.

### SUMMARY OF THE INVENTION

The present invention has been invented to solve the above-described problems, and one object is to synthesize reduced TiO₂ having dispersed —OH and Lewis acid active sites Ti·⁴⁺ by reducing with hydrogen the surface of non-reducible TiO₂ (oxidized TiO₂) having dispersed Brønsted acid active sites (—OH) and Lewis acid active sites Ti⁴⁺ and to improve the ·OH productivity of H₂O₂ homolysis (H₂O₂→2·OH) based on the heterogeneous catalytic phenomenon, thereby improving the decomposition efficiency of non-degradable organic matter.

In addition, another object of the present invention is to disperse NO³·, H₂PO₄·, HPO₄·⁻, or PO₄²·⁻ surface species on the reduced TiO₂ surface to further improve the decomposition efficiency of non-degradable organic matter based on the heterogeneous catalytic phenomenon.

In addition, still another object of the present invention is to provide a catalyst for electro-Fenton reaction system, an electrode including the same, and an electro-Fenton reaction system using the same, which are capable of inducing continuous ·OH production and solving problems such as slow non-degradable organic matter decomposition reaction rate and severe leaching of reaction active sites, which have been suggested as shortcomings of the existing electro-Fenton process.

In addition, yet another object of the present invention is to provide a catalyst for nonelectro-Fenton reaction system and a non-degradable organic matter decomposition system using the same, which are capable of solving problems such as slow non-degradable organic matter decomposition reaction rate and severe leaching of reaction active sites, which have been suggested as shortcomings of the existing electro-Fenton process. The technical tasks to be achieved by the present invention are not limited to the above-mentioned technical tasks, and other technical tasks not mentioned will be clearly understood by those skilled in the art to which the present invention pertains from the description below.

As a technical means to achieve the aforementioned technical task, one aspect of the present invention provides a catalyst for an electro- or nonelectro-Fenton reaction system, including: surface-reduced catalyst particles; or surface-reduced catalyst particles including a nitrate group or a phosphate group.

The catalyst particles may have a porous structure

The catalyst particles may have a diameter of 0.1 nm to 500 μm.

The catalyst particles may include TiO₂, ZrO₂, Nb₂O₅, or Ta₂O₅ as non-reducible transition metal oxides.

The nitrate group may be NO₃⁻ and the phosphate group may be one of H₂PO₄₋, HPO₄²⁻, or PO₄³⁻.

Another aspect of the present invention provides a preparation method of a catalyst for an electro- or nonelectro-Fenton reaction system, including: preparing catalyst particles having a reduced surface by hydrogen treatment.

The hydrogen treatment may be performed by a reaction gas including H₂.

The preparation method may further include: performing nitrification or phosphorylation treatment of the reduced catalyst particle surface.

The nitrification treatment may be performed by a reaction gas including NO and O₂.

The phosphorylation treatment may be performed by a reaction solution including a phosphorylation precursor.

Another aspect of the present invention provides an electrode for the electro- or nonelectro-Fenton reaction system, including: the catalyst for the electro- or nonelectro-Fenton reaction system; a carrier on which the catalyst is supported; a substrate coated with the carrier; and a binder interposed between the carrier and the substrate to increase coating adhesion.

The catalyst particles may have a porous structure.

The catalyst particles may have a diameter of 0.1 nm to 500 μm.

The carrier may be one of carbon (C), Al₂O₃, MgO, ZrO₂, CeO₂, and SiO₂.

The electrode may further include the catalyst in an amount of 0.01 to 50 parts by weight based on 100 parts by weight of the carrier.

The binder may be an insoluble polymer.

Another aspect of the present invention provides an electro- or nonelectro-Fenton reaction system including: the electrode for the electro- or nonelectro-Fenton reaction system; and an aqueous electrolyte solution.

The pH of the electrolyte solution may be 2 to 10, and the electrode may be input with a power of 2 W or less to cause a Fenton reaction.

The electro- or nonelectro-Fenton reaction may include: (1) forming ·OH species formed by a homolysis of H₂O₂; (2) converting NO₃⁻ surface species functionalized by the ·OH species or H₂PO₄⁻/HPO₄²⁻/PO₄³⁻ surface species into NO₃· surface species or converting into H₂PO₄·/HPO₄·⁻/PO₄·²⁻ surface species; and (3) decomposing non-degradable organic matter by one or more of the surface species of the NO³·, H₂PO₄·, HPO₄·⁻, or PO₄²·⁻.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 shows scanning electron microscopy (SEM) images of catalysts synthesized according to one embodiment of the present invention;

FIG. 2 shows a graph illustrating the X-ray diffraction (XRD) pattern results of the catalysts synthesized according to one embodiment of the present invention;

FIG. 3 shows a graph illustrating the X-ray photoelectron spectroscopy (XPS) results in the N 1s and P 2p regions of the catalysts synthesized according to one embodiment of the present invention;

FIG. 4 shows a graph illustrating the conversion rate and conversion concentration of acetaminophen decomposed over time under electro-Fenton conditions of the catalysts synthesized according to one embodiment of the present invention;

FIG. 5 shows a graph illustrating the conversion rate and conversion concentration of acetaminophen decomposed over time under electro-Fenton conditions of the catalysts synthesized according to one embodiment of the present invention;

FIG. 6 shows a graph illustrating the conversion rate and conversion concentration of acetaminophen decomposed over time under electro-Fenton conditions of the catalysts synthesized according to one embodiment of the present invention;

FIG. 7 shows a graph illustrating the decomposition rates of acetaminophen, aniline, sulfanilamide, and sulfamethoxazole (SMX) under electro-Fenton conditions of the catalysts synthesized according to one embodiment of the present invention; and

FIG. 8 shows a graph illustrating the decomposition rates of acetaminophen under nonelectro-Fenton conditions of the catalysts synthesized according to one embodiment of the present invention.

Hereinafter, the present invention will be described in more detail. However, the present invention may be implemented in various different forms, and the present invention is not limited to the embodiments described herein, and the present invention is only defined by the claims set forth below.

In addition, the terms used herein are only used to describe specific embodiments and are not intended to limit the present invention. Unless the context clearly indicates otherwise, the singular expression includes the plural expression. Throughout the specification of the present invention, unless otherwise specified, the term “comprising” means that other components may be included rather than meaning that other components are excluded.

Throughout the specification, when a portion is described to be “connected (linked, contacted, joined)” to another portion, this includes not only cases where it is “directly connected” but also cases where it is “indirectly connected” with another member therebetween. Also, when a portion is described to “comprise” a certain component, unless otherwise specified, this means that other components may be included rather than meaning that other components are excluded.

The terms used herein are only used to describe specific embodiments and are not intended to limit the present invention. Unless the context clearly indicates otherwise, the singular expression includes the plural expression.

A first aspect of the present invention provides a catalyst for an electro- or nonelectro-Fenton reaction system, including: surface-reduced catalyst particles; or surface-reduced catalyst particles including a nitrate group or a phosphate group.

Hereinafter, the catalyst for the electro- or nonelectro-Fenton reaction system according to the first aspect of the present invention is described in detail.

In one embodiment of the present invention, the catalyst particles may have a porous structure.

In one embodiment of the present invention, the catalyst particles may have a diameter of 0.1 nm to 500 μm. When the diameter of the catalyst particles exceeds the above range, the non-degradable organic matter decomposition rate may decrease, thus causing the problem that the decomposition performance is difficult to maintain.

In one embodiment of the present invention, the catalyst particles may include TiO₂, ZrO₂, Nb₂O₅, or Ta₂O₅ as non-reducible transition metal oxides, and preferably titanium dioxide (TiO₂) may be used.

In one embodiment of the present invention, the nitrate group may be NO₃⁻ and the phosphate group may be one of H₂PO₄⁻, HPO₄²⁻, PO₄³⁻.

A second aspect of the present invention provides a preparation method of a catalyst for an electro- or nonelectro-Fenton reaction system, including: preparing catalyst particles having a reduced surface by hydrogen treatment.

For portions that overlap the first aspect of the present application, a detailed description has been omitted, but the same contents described about the first aspect of the present application may be applied even when the description has been omitted for the second aspect.

Hereinafter, the preparation method of the catalyst for the electro- or nonelectro-Fenton reaction system according to the second aspect of the present invention is described in detail.

In one embodiment of the present invention, the hydrogen treatment may be performed by a reaction gas including H₂.

In one embodiment of the present invention, the preparation method may further include: performing nitrification or phosphorylation treatment of the reduced catalyst particle surface.

In one embodiment of the present invention, the nitrification treatment may be performed by a reaction gas including NO and O₂.

In one embodiment of the present invention, the phosphorylation treatment may be performed by a reaction solution including a phosphorylation precursor.

A third aspect of the present invention provides an electrode for the electro- or nonelectro-Fenton reaction system, including: the catalyst for the electro- or nonelectro-Fenton reaction system; a carrier on which the catalyst is supported; a substrate coated with the carrier; and a binder interposed between the carrier and the substrate to increase coating adhesion.

For portions that overlap the first and second aspects of the present application, a detailed description has been omitted, but the same contents described about the first and second aspects of the present application may be applied even when the description has been omitted for the third aspect.

Hereinafter, the electrode for the electro- or nonelectro-Fenton reaction system according to the third aspect of the present invention is described in detail.

In one embodiment of the present invention, the catalyst particles may have a porous structure.

In one embodiment of the present invention, the catalyst particles may have a diameter of 0.1 nm to 500 μm. When the diameter of the catalyst particles exceeds the above range, the non-degradable organic matter decomposition rate may decrease, thus causing the problem that the decomposition performance is difficult to maintain.

In one embodiment of the present invention, the carrier may be one of carbon (C), Al₂O₃, MgO, ZrO₂, CeO₂, and SiO₂.

In one embodiment of the present invention, the electrode may further include the catalyst in an amount of 0.01 to 50 parts by weight based on 100 parts by weight of the carrier.

In one embodiment of the present invention, the binder may be an insoluble polymer.

A fourth aspect of the present invention provides an electro- or nonelectro-Fenton reaction system including: the electrode for the electro- or nonelectro-Fenton reaction system; and an aqueous electrolyte solution.

For portions that overlap the first to third aspects of the present application, a detailed description has been omitted, but the same contents described about the first to third aspects of the present application may be applied even when the description has been omitted for the fourth aspect.

Hereinafter, the electro- or nonelectro-Fenton reaction system according to the fourth aspect of the present invention is described in detail.

In one embodiment of the present invention, the pH of the electrolyte solution may be 2 to 10, and the electrode may be input with a power of 2 W or less to cause a Fenton reaction.

In one embodiment of the present invention, the electro- or nonelectro-Fenton reaction may include: (1) forming ·OH species formed by a homolysis of H₂O₂; (2) converting NO₃⁻ surface species functionalized by the ·OH species or H₂PO₄⁻/HPO₄²⁻/PO₄³⁻ surface species into NO₃· surface species or converting into H₂PO₄·/HPO₄·⁻/PO₄·²⁻ surface species; and (3) decomposing non-degradable organic matter by one or more of the surface species of the NO₃·, H₂PO₄·, HPO₄·⁻, PO₄·²⁻.

Hereinafter, embodiments of the present invention will be described in detail so that those skilled in the art may easily implement the invention. However, the present invention may be implemented in various different forms and is not limited to the embodiments described herein.

### Comparative Example 1: Preparation of O300 Catalyst

6.9 g of H₂SO₄ and 11.25 g of TiOSO₄ were dissolved in 37.5 mL of distilled water, and the resulting solution was stirred at 50° C. for three hours, mixed with 75 g of urea dissolved in 500 mL of distilled water, and reflux-stirred at 110° C. for 18 hours. The intermediate product was cooled to 25° C., filtered, rinsed with 2 L of distilled water, and dried at room temperature for three hours to obtain TiO(OH)₂, which was calcined at 400° C. for three hours to synthesize O300, which was named as Comparative Example 1.

### Examples 1 and 2: Preparation of R300 and R600 Catalysts

TiO(OH)₂ was reduced at 300° C. for four hours with 10% by volume of H₂/He to synthesize R300, which was named Example 1. In addition, TiO(OH)₂ at 600° C. for four hours with 10% by volume of H₂/He to synthesize R600, which was named as Example 2.

### Examples 3 and 4: Preparation of R600-N and R600-P Catalysts

The R600 catalyst of Example 2 was mounted in a reactor, and nitrogen monoxide (NO) and oxygen (O₂) diluted with N₂ were simultaneously introduced at a flow rate of 500 mL min⁻¹ to expose the catalyst at 100° C. under normal pressure for 120 minutes, and then the catalyst was cooled to room temperature under N₂ atmosphere. The content of NO at the exposure stage was 5,000 ppm, and that of oxygen was 3% by volume. An NO₃⁻-functionalized R600-N catalyst corresponding to Example 3 was prepared according to the above conditions. 2 g of the R600 catalyst of Example 3 was added to 200 mL of an aqueous solution in which 4 mmol of a phosphorylation precursor ((NH₄)₂HPO₄) was dissolved, and the resulting mixture was stirred/dried at 25° C. for 24 hours, and then calcined at 250° C. for three hours. According to the above conditions, an H₂PO₄⁻/HPO₄²⁻/PO₄³⁻-functionalized R600-P catalyst corresponding to Example 4 was prepared according to the above conditions.

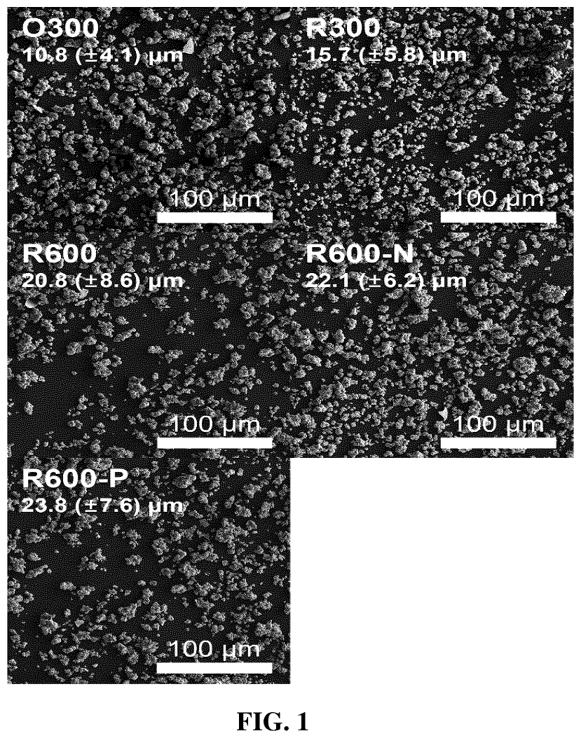

FIG. 1 shows the morphology of the catalyst particles of oxidized TiO₂ (O300), reduced TiO₂ (R300 and R600), NO₃⁻-functionalized reduced TiO₂ (R600-N), and H₂PO₄⁻/HPO₄²⁻/PO₄³⁻-functionalized reduced TiO₂ (R600-P) according to one embodiment of the present invention. As shown in FIG. 1, when the catalyst particles have a small size (10 to 30 μm) or have a rough surface including protrusions, since the surface area increases and thus the H₂O₂ homolysis (H₂O₂→2·OH) becomes faster, the formation rate of ·OH and the conversion rate of NO₃⁻/H₂PO₄⁻/HPO₄²⁻/PO₄³⁻ functional groups on the catalyst surface into NO₃·/H₂PO₄·/HPO₄·⁻/PO₄²·⁻ surface species by the ·OH species (NO₃⁻+·OH→NO₃·+OH⁻; H₂PO₄⁻+·OH→H₂PO₄·+OH⁻; HPO₄²−+·OH→HPO₄·⁻+OH⁻; PO₄³⁻+·OH→PO₄²·−+OH⁻) may become faster.

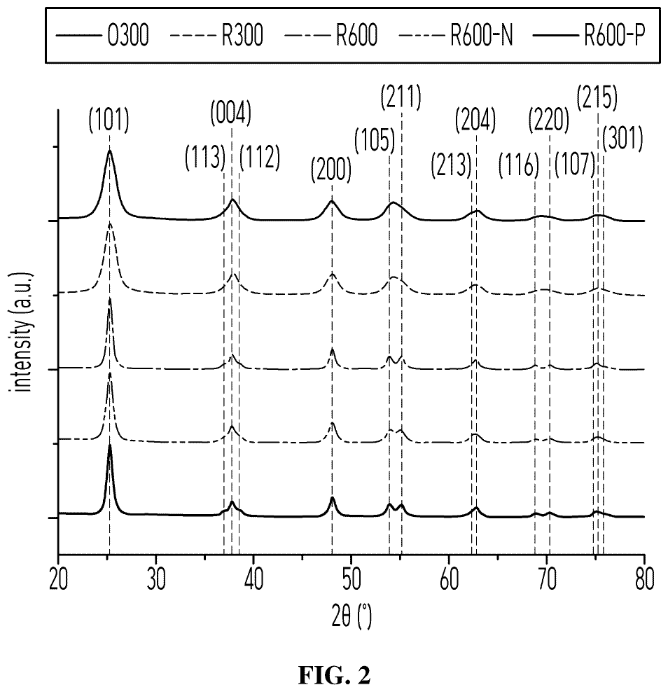

The catalysts prepared through Comparative Example 1 and Examples 1 to 4 were analyzed using an X-ray diffractometer (XRD), and the resulting XRD patterns are shown in FIG. 2. Referring to FIG. 2, it can be seen that the catalysts of Comparative Example 1 and Examples 1 to 4 have a tetragonal TiO₂ crystal phase. This means that the reduction by hydrogen at 300 to 600° C. or the functionalization with NO₃⁻/H₂PO₄⁻/HPO₄²⁻/PO₄³⁻ did not affect the bulk phase of TiO₂, but affected only the properties of the Brønsted acid (—OH)/Lewis acid (Ti·⁴⁺) present on the TiO₂ surface, or only the TiO₂ surface was modified by NO₃⁻/H₂PO₄⁻/HPO₄²⁻/PO₄³⁻.

Table 2 below shows the properties of the examples.

TABLE 2

| | Comparative | | | | |
|---|---|---|---|---|---|
| | Example 1 | Example 1 | Example 2 | Example 3 | Example 4 |
| Catalyst | O300 | R300 | R600 | R600-N | R600-P |
| S_{BET}^{a} (m² | 245.6 | 229.5 | 79.1 | 70.2 | 35.4 |
| g_{CAT}⁻¹) | | | | | |
| V_{BJH}^{b} (cm³ | 0.3 | 0.3 | 0.3 | 0.2 | 0.1 |
| g_{CAT}⁻¹) | | | | | |
| N/Ti (bulk)^{c,d} | — | — | — | 0.011 | — |
| | | | | (+0.005) | |
| N/Ti (surface)^{e} | — | — | — | 0.11 | — |
| | | | | (+0.01) | |
| P/Ti (bulk)^{c} | — | — | — | — | 0.136 |
| | | | | | (+0.003) |
| P/Ti (surface)^{e} | — | — | — | — | 0.31 |
| | | | | | (+0.04) |
| N_{CO2}^{f} (μmol_{CO} | 1.55 | 1.60 | 1.49 | — | — |
| g_{CAT}_{^{−1}}) | (+0.16) | (+0.07) | (+0.12) | | |
| N_{CO2}^{g} | 566.9 | 569.9 | 147.7 | 82.3 | 20.6 |
| (μmol_{CO2} | (+8.9) | (+1.0) | (+33.3) | (+15.0) | (+0.7) |
| g_{CAT}⁻¹) | | | | | |
| band gap^{h} | 3.3 | 3.3 | 3.3 | 3.2 | 3.1 |
| (eV) | | | | | |

^{a}via BET.
^{b}via BJH.
^{c}via ICP.
^{d}via EA.
^{e}via XPS.
^{f}via CO-pulsed chemisorption at 40° C.
^{g}via CO₂ isotherm at 20° C.
^{h}via Tauc plot.

Table 2 shows the results of analyzing the properties of the catalysts of Comparative Example 1 and Examples 1 to 4. The catalysts of Comparative Example 1 and Examples 1 to 4 show porous morphology, which is proven by the Brunauer-Emmett-Teller (BET) surface area values (S_{BET}) and Barrett-Joyner-Halenda BJH pore volume values (V_{BJH}) of the catalysts. In addition, according to the results of quantitative analyses using inductively coupled plasma-optical emission spectrometry/elemental analysis (ICP/EA) and X-ray photoelectron spectroscopy (XPS), the catalysts of Examples 3 and 4 contain N and P in the bulk and on the surface (N/Ti and P/Ti molar ratios), which means that the R600 (reduced TiO₂) surface was functionalized with NO₃⁻/H₂PO₄⁻/HPO₄²⁻/PO₄³⁻.

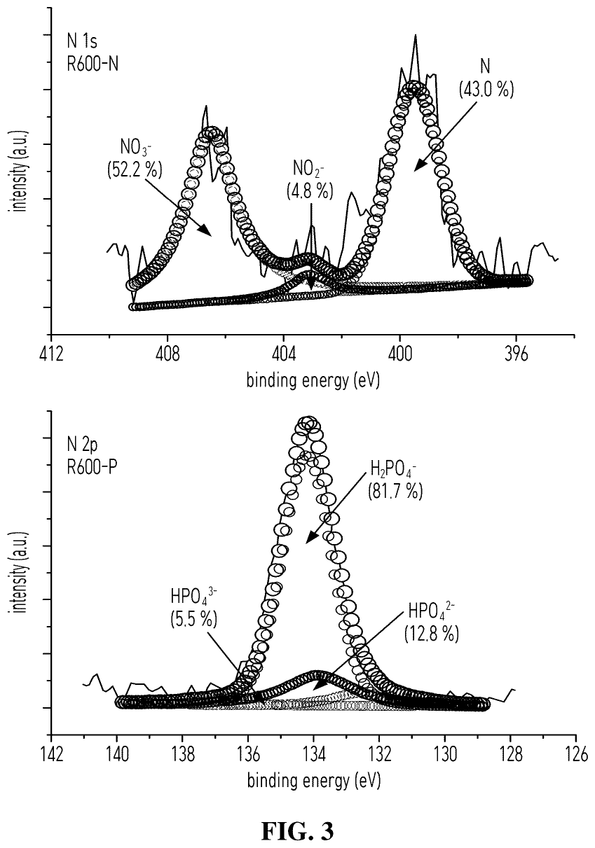

FIG. 3 shows a graph illustrating the XPS results of the catalysts of Examples 3 and 4 functionalized with NO₃⁻/H₂PO₄⁻/HPO₄²⁻/PO₄³⁻ (N 1s for Example 3; P 2p for Example 54). As proven by the XPS results, it was found that the catalysts of Examples 3 and 4 contained NO₃⁻/H₂PO₄⁻/HPO₄²⁻/PO₄³⁻ functional groups on the surface. Specifically, this means that the catalysts of Examples 3 and 4 contain N/P in the bulk and on the surface (Table 2) and contain NO₃⁻/H₂PO₄⁻/HPO₄²⁻/PO₄³⁻ functional groups on the surface, and thus may generate NO₃·/H₂PO₄·/HPO₄·⁻/PO₄²·⁻ for non-degradable organic matter decomposition based on the radical transfer reaction.

On the other hand, to quantify the number of Lewis acids (NCO) per unit gram of the catalysts of Comparative Example 1 and Examples 1 to 4, a CO-pulsed chemisorption analysis was performed at 40° C. As a result, the numbers of NCO of the catalysts of Comparative Example 1 and Examples 1 to 4 were similar, which means that the numbers of Lewis acids of all the catalysts of the examples were similar. In addition, to quantify the number of total acid sites (Brønsted acid and Lewis acid) (NCO₂) per unit gram of the catalysts of Comparative Example 1 and Examples 1 to 4, a CO₂ isotherm analysis was performed at 20° C. As a result, the NCO₂ value decreased from Comparative Example 1/Example 1 to Example 4, which means that the number of total acid sites decreased from Comparative Example 1/Example 1 to Example 4. In other words, the results of the CO-pulsed chemisorption and the CO₂ isotherm analysis prove that the main acid sites that determine the H₂O₂ homolysis in the catalysts of Comparative Example 1 and Examples 1 to 4 are the Brønsted acid sites, not the Lewis acid sites. More specifically, the rate-determining step (·OH desorption) of the H₂O₂ homolysis (H₂O₂→2·OH) that occurs in the catalysts of Comparative Example 1 and Examples 1 and 2 is determined by their Brønsted acid sites, and the rate-determining step (·OH desorption) of the radical transfer reactions (NO₃⁻+·OH→NO₃·+OH⁻; H₂PO₄⁻+·OH→H₂PO₄·+OH⁻; HPO₄²⁻+·OH→HPO₄·⁻+OH⁻; PO₄³⁻+·OH→PO₄²·⁻+OH⁻) that occur in the catalysts of Examples 3 and 4 is determined by their Brønsted acid sites.

The band gaps of the catalysts of Comparative Example 1 and Examples 1 to 4 were quantified using a Tauc plot, and are shown in Table 2. As a result, the band gaps of the catalysts of Comparative Example 1 and Examples 1 to 4 were found to be 3.1 to 3.3 eV, which means that the catalysts of Comparative Example 1 and Examples 1 to 4 are incapable of activating reactions that generate radicals by the above-described semiconduction mechanism or heterojunction mechanism. In addition, this means that the catalysts of Comparative Example 1 and Examples 1 and 2 generate ·OH based on the H₂O₂ homolysis to decompose non-degradable organic matter, and the catalysts of Examples 3 and 4 generate NO₃· surface species or H₂PO₄·/HPO₄·⁻/PO₄·²⁻ surface species based on the radical transfer reaction to decompose non-degradable organic matter.

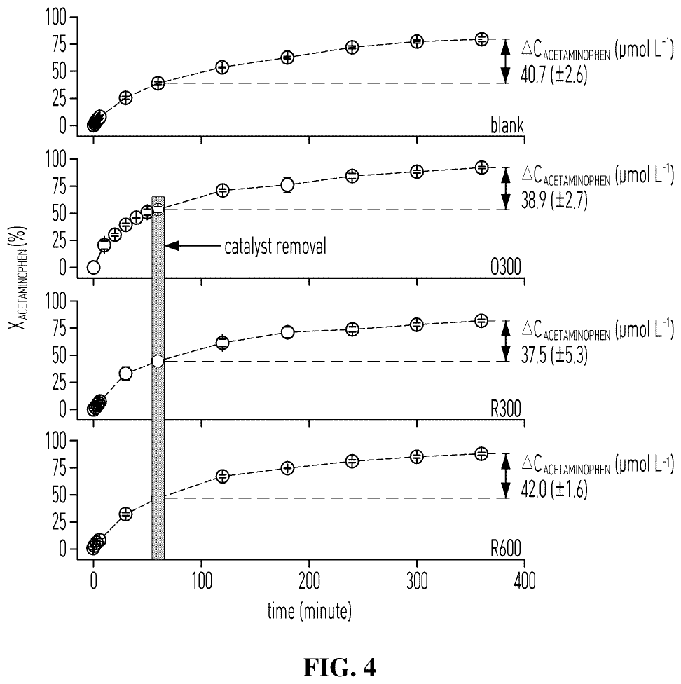

Hereinafter, the performance of an electro- or nonelectro-Fenton system using the catalysts of Comparative Example 1 and Examples 1 to 4 will be described with reference to FIGS. 4 to 7.

### Experimental Example 1: Acetaminophen Decomposition Based on Heterogeneous Catalysis

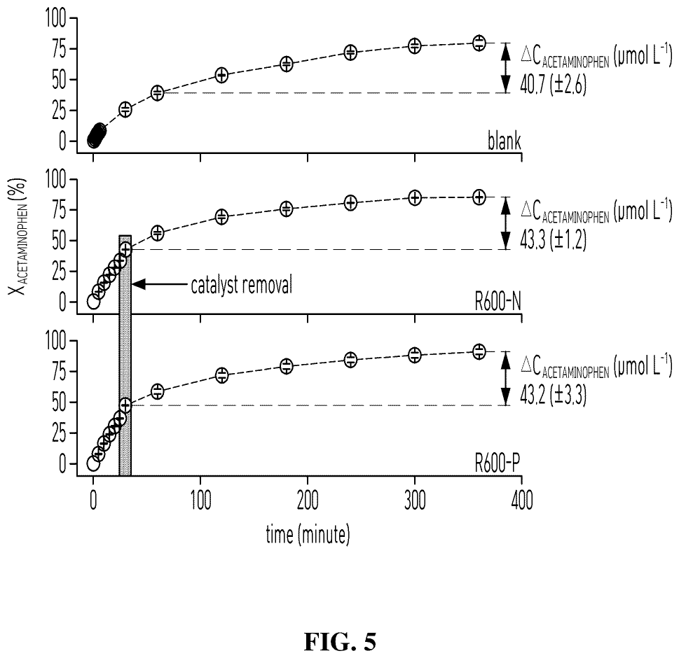

To verify that the decomposition of acetaminophen is carried out by the ·OH generated as a result of the H₂O₂ homolysis occurring on the catalyst surface, Experimental Example 1 was performed using Comparative Example 1 and Examples 1 and 2 as catalysts. In addition, to verify that the decomposition of acetaminophen is carried out by NO₃·/H₂PO₄·/HPO₄·⁻/PO₄²· on the catalyst surface, Experimental Example 1 was performed using Examples 3 and 4 as catalysts. Specifically, an electro-Fenton reaction experiment was performed using Comparative Example 1 and Examples 1 to 4 as catalysts, a graphite electrode as electrode, acetaminophen as an organic matter, and a Na₂SO₄ electrolyte solution. When coating the electrode with a catalyst, polyvinylidene fluoride (PVDF) was used as a binder. 0.2 g of the catalyst was used, and 100 mL of an aqueous solution in which 0.1 mmol of acetaminophen (N_{ACETAMONIPHEN, 0}) and 0.14 mmol of Na₂SO₄ were dissolved was used as a reaction solution. The electro-Fenton reaction experiment was performed at 25° C. and pH 7 with 0.04 W of power. At this time, after performing the acetaminophen decomposition experiment for one hour, the cathodes of Comparative Example 1 and Examples 1 to 4 were replaced with catalyst-free cathodes and the aqueous solution for the reaction was filtered, and the experiment was performed again. In addition, the acetaminophen conversion rate (X_{ACETAMINOPHEN}) versus time (reaction time) or the acetaminophen concentration values decomposed for one to six hours (C_{ACETAMINOPHEN}) obtained in the present experiment were compared with those (X_{ACETAMINOPHEN} versus time and C_{ACETAMINOPHEN}) of the experiment conducted with a catalyst-free under the same conditions. Importantly, the consumption of acetaminophen observed after one hour as due to the oxidation occurring at the anode even in the absence of a catalyst (anodic oxidation) or the H₂O₂ homolysis by the NO₃·/H₂PO₄·/HPO₄·⁻/PO₄²· reactive species leached from the catalyst (·OH generation; Comparative Example 1 and Examples 1 and 2) or to the NO₃·/H₂PO₄·/HPO₄·⁻/PO₄²· reactive species leached from the catalyst (Examples 3 and 4). The X_{ACETAMINOPHEN} versus time and C_{ACETAMINOPHEN} decomposed for one to six hours by the method was monitored and shown in FIGS. 4 and 5.

Referring to FIGS. 4 and 5, the conversion amounts of acetaminophen (ΔC_{ACETAMINOPHEN}) after one hour in the cathodes of Comparative Example 1, Example 1, Example 2, Example 3, and Example 4 were found to be 38.9 (±2.7) μM, 37.5 (±5.3) μM, 42.0 (±1.6) μM, 43.3 (±1.2) μM, and 44.2 (±3.3) μM. These values are similar to 40.7 (±2.6) μM, which is ΔC_{ACETAMINOPHEN} due to anodic oxidation, which was observed in the reaction performed without coating the cathode with the catalysts of Comparative Example 1 and Examples 1 to 4. This means that the acetaminophen decomposition reaction occurs based on heterogeneous catalysis by ·OH (Comparative Example 1, Example 1 and Example 2) or NO₃·/H₂PO₄·/HPO₄·⁻/PO₄²· reactive species (Examples 3 and 4) generated by H₂O₂ decomposition active species that are firmly coated on the electrode and not leached.

### Experimental Example 2: Decomposition of Acetaminophen, Aniline, Sulfanilamide, and Sulfamethoxazole (Electro-Fenton Reaction)

An electro-Fenton reaction experiment was performed using Comparative Example 1 and Examples 1 to 4 as catalysts, a graphite electrode as an electrode, acetaminophen, aniline, sulfanilamide, and sulfamethoxazole (SMX) as organic substances, and an aqueous Na₂SO₄ electrolyte solution. When coating the electrode with a catalyst, PVDF was used as a binder. 0.2 g of the catalyst was used, and 100 mL of an aqueous solution in which 0.1 mmol of the organic substance (N_{ORGANICS, 0}) and 0.14 mmol of Na₂SO₄ were dissolved was used as a reaction solution. The electro-Fenton reaction experiment was performed at 25° C. and pH 7 with 0.04 W of power. The slope of the pseudo-1^{st}-order kinetic fitting graph (−ln(C_{ORGANIC}/C_{ORGANIC, 0}) VS. time) obtained through the conversion rate of the organic substances obtained in the above experiment is equal to the rate constant (k_{APP}, min⁻¹) of the reaction in which the organic substances are decomposed. The k_{APP} of each catalyst was multiplied by N_{ORGANICS, 0} (0.1 mmol) and divided by the NCO₂ value (the mole number of total acid sites per gram of catalyst accessible to CO₂ as described above; set forth in Table 2) included in the used amount of the catalyst (0.2 g) to calculate the initial organic substance decomposition reaction rate (−r_{ORGANICS, 0}, min⁻¹), which is shown in

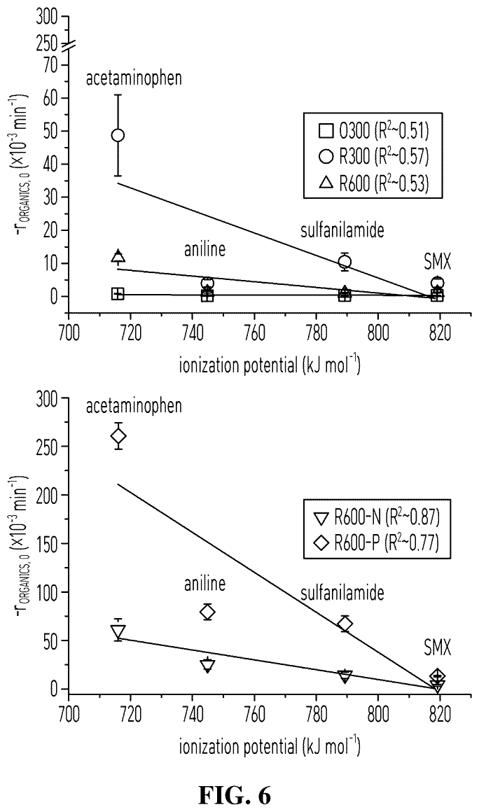

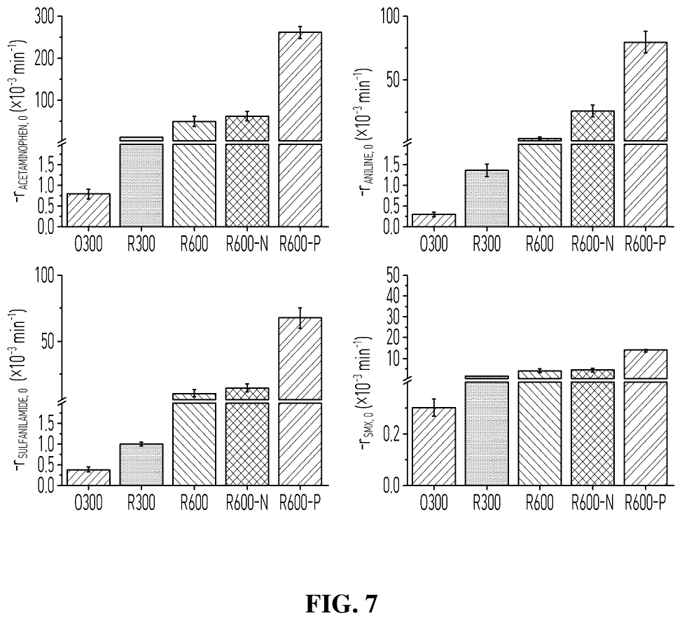

FIGS. 6 and 7.

The ionization energy, which is the energy required to remove an electron (e⁻) from an organic substance, is 715.9 kJmol⁻¹ for acetaminophen, 744.9 kJmol⁻¹ for aniline, 789.2 kJmol⁻¹ for sulfanilamide, and 819.1 kJmol⁻¹ for sulfamethoxazole (SMX). When a radical follows the e⁻ transfer mechanism in which an electron (e⁻) is removed from an organic substance to initiate decomposition, −r_{ORGANICS, 0} decreases as the ionization energy of the organic substances increases.

The −r_{ORGANICS, 0} values of R600-N of Example 3 and R600-P of Example 4 decrease as the ionization energy of the organic substances increases, which is proved by the high correlation coefficient values (R²≥0.77; FIG. 6) of −r_{ORGANICS, 0} versus the ionization energy of R600-N and R600-P, and this is consistent with a previous report that NO₃·/H₂PO₄·/HPO₄·⁻/PO₄²· initiate organic matter decomposition by the e⁻ transfer mechanism. On the other hand, the correlation coefficient values (R²; FIG. 6) of −r_{ORGANICS, 0} versus the ionization energy of O300 of Comparative Example 1, R300 of Example 1, and R600 of Example 2 are low as 0.57 or less, which is consistent with a previous report that ·OH initiates organic matter decomposition by addition or H· abstraction. The −r_{ORGANICS, 0} values increase in the order of O300 of Comparative Example 1<R300 of Example 1<R600 of Example 2, which means that the preferable properties of a Brønsted acid (—OH), which is a major acid site that determines the H₂O₂ homolysis (·OH production), are inherent in the reduced TiO₂ (R300 and R600). In addition, R600-N of Example 3 exhibited a similar or higher −r_{ORGANICS, 0} value than that of R600 of Example 2, which means that NO₃· surface species are more preferable for increasing the organic matter decomposition efficiency than the traditional ·OH under the electro-Fenton conditions. In addition, R600-P of Example 4 exhibited the highest −r_{ORGANICS, 0} value among Comparative Example 1 and Examples 1 to 4 prepared in the present invention, which means that the H₂PO₄·/HPO₄·⁻/PO₄²· surface species realizes superior organic matter decomposition efficiency compared to the traditional ·OH under the electro-Fenton conditions.

### Experimental Example 3: Acetaminophen Decomposition (Nonelectro-Fenton Reaction)

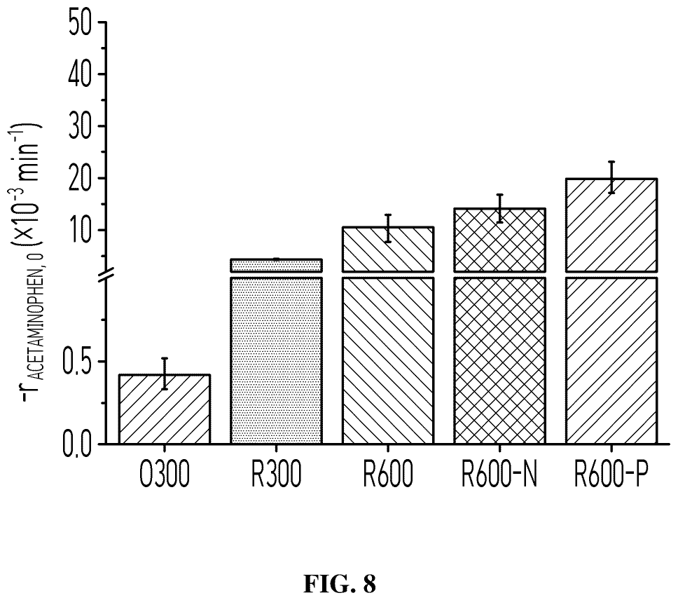

A reaction experiment was performed using Comparative Example 1 and Examples 1 to 4 as catalysts and H₂O₂ dissolved in an aqueous solution and acetaminophen, which is a non-biodegradable organic substance. 0.2 g of the catalyst was used, and 100 mL of an aqueous solution was used as a reaction solution. The reaction experiment was performed at 25° C. and pH 7, and the amount of H₂O₂ used in the reaction was 30 mmol, and the amount of acetaminophen (N_{ACETAMINOPHEN, 0}) was 0.1 mmol. The slope of the pseudo-1^{st}-order kinetic fitting graph (−ln(C_{ACETAMINOPHEN}/C_{ACETAMINOPHEN, 0}) VS. time) obtained through the conversion rate of acetaminophen obtained in the above experiment is equal to the rate constant (k_{APP}, min⁻¹) of the reaction in which acetaminophen is decomposed. The k_{APP} of each catalyst was multiplied by N_{ACETAMINOPHEN, 0} (0.1 mmol) and divided by the NCO₂ value (the mole number of total acid sites per gram of catalyst accessible to CO₂ as described above; set forth in Table 2) included in the used amount of the catalyst (0.2 g) to calculate the initial acetaminophen decomposition reaction rate (−r_{ACETAMINOPHEN, 0}, min⁻¹), which is shown in FIG. 8.

The −r_{ACETAMINOPHEN, 0} values increase in the order of O300 of Comparative Example 1<R300 of Example 1<R600 of Example 2<R600-N of Example 3<R600-P of Example 4, which means that the preferable properties of a Brønsted acid (—OH), which is a major acid site that determines the H₂O₂ homolysis (·OH production), are inherent in the reduced TiO₂ (R300 and R600). In addition, this means that the NO₃·/H₂PO₄·/HPO₄·⁻/PO₄²− surface species are more preferable for increasing the organic matter decomposition efficiency than the traditional ·OH under the nonelectro-Fenton conditions.

According to embodiments of the present invention, the proposed catalysts can be applied to the oxidative decomposition of wastewater, residual water-soluble pharmaceuticals, water-soluble environmental hormones, and chemical warfare agents.

In addition, according to one embodiment of the present invention, the reduced TiO₂ can provide improved. ··OH productivity in the homogeneous decomposition reaction of hydrogen peroxide compared to oxidized TiO₂, and thus the reduced TiO₂ can dramatically improve the reaction rate of non-degradable organic matter decomposition compared to oxidized TiO₂.

In addition, according to one embodiment of the present invention, the NO₃⁻, H₂PO₄⁻, HPO₄²⁻, or PO₄³⁻-functional group on the reduced TiO₂ catalyst surface can react with ·OH to be converted into NO₃·, H₂PO₄·, HPO₄·⁻, or PO₄²·− surface species that 1) have a longer lifetime and similar oxidation power compared to ·OH, but 2) are operated under wider pH conditions, thereby dramatically improving the reaction rate of non-degradable organic matter decomposition.

In addition, according to one embodiment of the present invention, leaching of catalyst particles occurring during non-degradable organic matter decomposition can be almost completely avoided, and thus, the performance of non-degradable organic matter decomposition can be maintained even after multiple uses of the catalyst, and the catalyst lifetime can be improved.

It should be understood that the effects of the present invention are not limited to the above-described effects and include all effects that may be inferred from the features of the invention described in the detailed description or claims of the present invention.

The above description of the present invention is for illustrative purposes, and those skilled in the art will understand that the present invention can be easily modified into other specific forms without changing the technical idea or essential characteristics of the present invention. Therefore, it should be understood that the embodiments described above are illustrative in all respects and not restrictive. For example, each component described as a single component may be implemented in a distributed manner, and likewise, components described as distributed may be implemented in a combined form.

The scope of the present invention is indicated by the claims set forth below, and all changes or modifications derived from the meaning and scope of the claims and their equivalent concepts should be interpreted as being included in the scope of the present invention.

What is claimed is:

1. A catalyst for an electro- or nonelectro-Fenton reaction system, comprising surface-reduced catalyst particles; or surface-reduced catalyst particles including a nitrate group or a phosphate group.

2. The catalyst for the electro- or nonelectro-Fenton reaction system according to claim 1, wherein the catalyst particles have a porous structure.

3. The catalyst for the electro- or nonelectro-Fenton reaction system according to claim 1, wherein the catalyst particles have a diameter of 0.1 nm to 500 μm.

4. The catalyst for the electro- or nonelectro-Fenton reaction system according to claim 1, wherein the catalyst particles include TiO₂, ZrO₂, Nb₂O₅, or Ta₂O₅ as non-reducible transition metal oxides.

5. The catalyst for the electro- or nonelectro-Fenton reaction system according to claim 1, wherein the nitrate group is NO₃⁻ and the phosphate group is one of H₂PO₄⁻, HPO₄²⁻, and PO₄³⁻.

6. A preparation method of a catalyst for an electro- or nonelectro-Fenton reaction system, comprising: preparing catalyst particles having a reduced surface by hydrogen treatment.

7. The preparation method of the catalyst for the electro- or nonelectro-Fenton reaction system according to claim 6, wherein the hydrogen treatment is performed by a reaction gas including H₂.

8. The preparation method of the catalyst for the electro- or nonelectro-Fenton reaction system according to claim 6, further comprising: performing nitrification or phosphorylation treatment of the reduced catalyst particle surface.

9. The preparation method of the catalyst for the electro- or nonelectro-Fenton reaction system according to claim 8, the nitrification treatment is performed by a reaction gas including NO and O₂.

10. The preparation method of the catalyst for the electro- or nonelectro-Fenton reaction system according to claim 8, the phosphorylation treatment is performed by a reaction solution including a phosphorylation precursor.

11. An electrode for an electro- or nonelectro-Fenton reaction system, comprising:
a catalyst for an electro- or nonelectro-Fenton reaction system of claim 1;
a carrier on which the catalyst is supported;
a substrate coated with the carrier; and
a binder interposed between the carrier and the substrate to increase coating adhesion.

12. The electrode for the electro- or nonelectro-Fenton reaction system according to claim 11, wherein the catalyst particles have a porous structure.

13. The electrode for the electro- or nonelectro-Fenton reaction system according to claim 11, wherein the catalyst particles have a diameter of 0.1 nm to 500 μm.

14. The electrode for the electro- or nonelectro-Fenton reaction system according to claim 11, wherein the carrier is one of carbon (C), Al₂O₃, MgO, ZrO₂, CeO₂, and SiO₂.

15. The electrode for the electro- or nonelectro-Fenton reaction system according to claim 11, comprising the catalyst in an amount of 0.01 to 50 parts by weight based on 100 parts by weight of the carrier.

16. The electrode for the electro- or nonelectro-Fenton reaction system according to claim 11, wherein the binder is an insoluble polymer.

17. An electro- or nonelectro-Fenton reaction system comprising one or more of the electrode of claim 11 and an aqueous electrolyte solution.

18. The electro- or nonelectro-Fenton reaction system according to claim 17, wherein the pH of the electrolyte solution is 2 to 10, and the electrode is input with a power of 2 W or less to cause a Fenton reaction.

19. The electro- or nonelectro-Fenton reaction system according to claim 17, wherein the catalyst included in the electrode has a powder form.

20. The electro- or nonelectro-Fenton reaction system according to claim 17, wherein the electro- or nonelectro-Fenton reaction includes:
(1) forming ·OH species formed by a homolysis of H₂O₂;
(2) converting NO₃⁻ surface species functionalized by the ·OH species or H₂PO₄⁻/HPO₄²⁻/PO₄³⁻ surface species into NO₃· surface species or converting into H₂PO₄·/HPO₄·⁻/PO₄²·⁻ surface species; and
(3) decomposing non-degradable organic matter by one or more of the surface species of the NO₃·, H₂PO₄·, HPO₄·⁻, and PO₄²·⁻.
